(19) United States
(12) Patent Application Publication
(10) Pub. No.: US 2022/0188877 A1
(43) Pub. Date: Jun. 16, 2022

(54) METHODS AND SYSTEMS FOR VIDEO GAME LIVE STREAMING

(71) Applicant: Bidstack Group PLC, London (GB)

(72) Inventors: Jevgenijs Fokins, Riga (LV); Francesco Petruzzelli, London (GB); Arvids Kokins, Riga (LV)

(73) Assignee: Bidstack Group PLC, London (GB)

(21) Appl. No.: 17/124,095

(22) Filed: Dec. 16, 2020

(51) Int. Cl. G06Q 30/02; H04N 21/2187; H04N 21/81; H04N 21/234; A63F 13/355

(52) U.S. Cl. CPC G06Q 30/0277; H04N 21/2187; H04N 21/812; G06Q 30/0269; A63F 13/355; G06Q 30/0255; H04N 21/23424

(57) ABSTRACT

Ad servers, live streaming systems and user devices that provide complementary advertisements to the viewers of live stream broadcasts are provided. The complementary advertisements relate to or complement an in-game advertisement present in the live streams. This allows for advertisements and advertising campaigns that are better targeted, more effective, and more easily monitored. Advertisements that are served may be better targeted, more effective and interactive. Techniques presented herein may reduce the computer resources required for advertising and increase public safety, for example, by avoiding children and minors being served advertisements for age restricted products.

### FIELD

What is disclosed herein relates to advertisements served to viewers of a video game live streams. Advertisements that are served according to the what is disclosed herein may be better targeted, more effective and interactive. What is disclosed herein may reduce the computer resources required for advertising and increases public safety (e.g. by avoiding children and minors being served advertisements for age restricted products).

### BACKGROUND

Watching video game live streams is an increasingly common pastime. During a video game live stream a video game player records themselves playing a video game and broadcasts their play to a live audience via the internet. The broadcast often includes commentary and/or video of the player in addition to video of the game play itself. Viewers may also watch the broadcast live stream at a later point in the form of a replay or rebroadcast live stream.

Popular live streaming services include Twitch®, YouTube®, and Facebook Gaming®. Viewers may watch video game live streams through these services via a web browser or app (i.e. an application).

Systems exist that serve advertisements (also termed “ads” or “adverts”) to video game players during game play. For instance, in a racing video game a player may drive past a billboard that holds an advertisement. Whereas, in a sports video game advertisements may be provided on the billboards and advertising hoardings in a sports stadium, whilst sponsors may be advertised on player's uniforms. Historically these in-game advertisements have been fixed by the developer or publisher of the video game at sale—i.e. the advertisements are present in the code of the video game and do not change over time.

However, recent systems are capable of inserting in-game advertisements into video games in real time. The computer or video game console that a video game player is playing on may request and receive advertisements from an Ad Server, and these advertisements may be immediately inserted into the game. Thus a video game player may be served a contemporary advertisement many months after the game is published.

In a video game live streaming setting, the in-game advertisements inserted into a video game will not only be seen by the video game player, but also the audience of viewers watching the live stream. Indeed, the advertisements may be seen by hundreds or thousands of viewers.

Consequently the number of people who can view an in-game advertisement is significantly increased due to video game live streaming For instance, it may be appreciated that whilst the in-game advertisement may only be seen by a single “primary viewer”—the video game player—who directly observes the in-game advertisement in the video game, there may be many more “secondary viewers” of the in-game advertisement who are watching a live stream of the game play of the player and observe the in-game advertisement via the live stream. However, there are a number of limitations inherent to these conventional systems and methods.

Notably, a viewer of the live stream is unable to interact with the in-game advertisement. This is because a viewer receives a video that is broadcast by the video game player. Unlike in conventional digital advertising, the viewer is unable to click on or interact with the advertisement shown in the game play broadcast by the video game player. For instance, a viewer is unable to receive further information regarding an advertisement or an advertised product, and/or cannot be directed to an online store for an advertised product. Therefore, these adverts may be less effective than conventional advertisements.

Advertisers are also unable to track or monitor the number of additional secondary viewers who view an in-game advertisement through live streams. Therefore, it is not possible to quantify how successful an advertising campaign involving in-game advertisement has been.

In addition, an advertisement served to and inserted into a video game may be unsuitable or inappropriate for a viewer of a live stream. For instance, an adult video game player may be served an in-game advertisement directed to an alcohol or tobacco product. This advertisement may not be suitable for an underage child or minor viewing a live stream of the adult video game player.

There is a need for improved systems and methods that overcome at least some of the disadvantages and limitations discussed above.

### SUMMARY

What is disclosed herein provides ad servers, live streaming systems and user devices that provide complementary advertisements to the viewers of live stream broadcasts, these complementary advertisements relating or complementing an in-game advertisement present in the live stream. This offers advertisements (also referred to as “ads” and “adverts”, with each individually an “ad”, herein) and advertising campaigns that are better targeted, more effective and more easily monitored. Further benefits offered by the what is disclosed herein will be discussed below with reference to the specific examples.

In accordance with an aspect there is provided a method performed by an ad server comprising the steps of: receiving from a live streaming system a notification informing the ad server of a live stream being broadcast or to be broadcast by the live streaming system to a user device, the live stream comprising video of game play from a video game and an in-game advertisement; wherein the notification comprises data associated with the live stream; identifying an asset of a complementary advertisement which relates to the in-game advertisement based on the data in the notification; and providing the asset to the live streaming system, such that the live stream may be presented to a viewer together with a complementary advertisement comprising the asset.

Therefore what is disclosed herein is capable of serving complementary ads to viewers of a live stream that match or relate to in-game advertisements shown in the live stream. The link between the in-game and complementary ads can reinforce the effect of the advertisements on a viewer, increasing the effectiveness of an advertising campaign. This approach provides a particularly efficient means of advertising to viewers of a live stream. Linking complementary ads to in-game ads allows the provision of a given complementary ad to be targeted to reach only viewers of live streams that contain a related in-game ad. Therefore, the required computational resources may be reduced since it is not necessary to serve a complementary ad to all viewers of a live streaming service, only those that view a corresponding in-game ad. Thus a complementary ad may not be displayed to viewers of the live streaming system that are watching live streams that do not include a related or corresponding in-game ad.

In other words the targeted approach to advertising provided in what is disclosed herein allows for the number of viewable impressions—a measure of the number of times a digital advertisement is sufficiently visible to the user of a web service—to be increased whilst reducing the necessary computational resources.

It will be appreciated that the ad server organizes the provision of assets for the complementary ad to the live streaming system such that the complementary ad may be presented to the viewer with an in-game ad. Such in-game ads are advertisements that are presented (i.e. displayed or sounded) to the video game player during game play, and are subsequently broadcast to viewers of the live stream. The in-game ad may comprise one or more image, animation, video, text or audio assets. In some examples the in-game ad may be displayed or presented as part of a loading screen or menu screen. As such the in-game ad may take the form of a conventional banner or button ad. However, in more complex examples the in-game ad may be inserted into the game world of the video game—e.g. the ad may be shown on a billboard, poster or advertising hoarding within the virtual game world.

The complementary ad may be presented or served to the viewer together with the live stream. As such, the complementary ad may be presented simultaneously with, before, after or as a break within the live stream. Suitable types of advertisements that may be used as complementary ads include banner ads, overlay ads, web page takeovers, video player takeovers, pre-roll, post-roll or mid-roll ads, interstitial ads (e.g. that run before, within or after the live stream) and pop-up ads. Each complementary ad may comprise one or more image, animation, video, text or audio assets.

As discussed above, the complementary ad relates to the in-game ad. As such the complementary ad may be conceptually linked or related to the in-game ad. For instance, the complementary ad may be for the same product, service or company as the in-game ad. Indeed, the complementary ad may form part of the same ad campaign and may share one or more assets with the in-game ad. Alternatively, the complementary ad may be for a related company, service and/or product as the one presented in in-game ad. For instance, a complementary ad may be for a product or service for use with the product or service shown in the in-game ad (e.g. if the in-game ad is for a car, the complementary ad may be for a type of petrol). Alternatively, the complementary ad may be for a competitor to a company or service presented in the in-game ad.

The relationship between the in-game ads and complementary ads (i.e. between the in-game ad and the assets for use in complementary ads) may be pre-defined and stored by the ad server. Thus, optionally the method may comprise the steps of defining and/or storing relationships between in-game ads and assets for use in complementary ads.

Herein, the term “live stream” will be understood as multimedia that is recorded and broadcast live. The live streams discussed above are recorded and broadcast in real time by a video game player, and include video of the game play from the video game. The live stream may be viewed in real-time by a viewer, but this is not essential. A viewer may also watch a replayed or rebroadcast live stream at a later point—e.g. as part of video on demand (VOD). Thus the term “live” within live stream refers to the creation of the media rather than its consumption. Indeed, the systems and methods herein are capable of presenting (e.g. displaying) complementary ads to viewers who watch a live stream in real time and/or viewers who watch a replayed live stream.

The term “presented” will be understood to any manner in which media is shown, played or displayed to a viewer. As such it will be understood as covering the display of images, text, videos and animations (e.g. on a display screen) on a screen and the playing of music or other audio (e.g. using speakers or headphones).

The notification received by the ad server may take the form of a request from the live streaming system for an asset of a complementary ad. Alternatively, the notification may simply inform the ad server of the existence of a live stream, following which the ad server may decide to provide an asset to the live stream system—e.g. in response to a further input such as the notification of an in-game event occurring within the video game (as discussed further below).

Optionally, the method comprises the step of identifying that the live stream comprises an in-game advertisement based on the data in the notification from the live streaming system.

Preferably, the method comprises the step of identifying the in-game advertisement within the live stream based on the data in the notification from the live streaming system. Thus the ad server may identify the specific in-game advertisement present within the live stream—e.g. using the data associated with the live stream. Having identified the in-game advertisement, the ad server may subsequently select or identify assets which relate or correspond to the in-game advert that may then be presented to a viewer as part of a complementary advertisement.

By performing these steps at an ad server the impact of what is disclosed herein on live streaming systems can be minimised. The improved ad server may be easily integrated into existing live streaming architecture. As such, actions required by a live streaming service operating the live streaming system may be minimised. Indeed, if the existence of an in-game advertisement cannot be confirmed or if the ad server cannot identify an in-game advertisement, the ad server may provide assets of an alternative advertisement to be presented to the live stream viewer with the live stream.

However, in alternative examples the existence of an in-game ad may be ascertained and the identity of the in-game ad may be determined elsewhere. For instance, in some embodiments the live streaming system may identify that an in-game advertisement exists in the live stream and/or identify the specific in-game advertisement. In such situations the live streaming system may provide this information to the ad server as part of the data associated with the live stream. Alternatively, information regarding the in game ad may be provided directly from the video game system broadcasting the live stream to the ad server.

The data associated with the live stream may include metadata of the live stream; data associated with the video game, data associated with the video game system on which the video game is being played and/or data associated with the video game player who is live streaming the video game. This data may be shared between all components of the wider system—i.e. between the ad server, live streaming system and user devices.

Metadata associated with the live stream could include a timestamp (e.g. of when the live stream began), a live stream session identifier, a live stream title and details of a channel or account broadcasting the live stream. Details of the channel or account broadcasting the live stream could include the IP address, channel or account title, an email address, and/or details of whether the channel or account is part of a partnership program with the live streaming service that operates the live streaming system. Data associated with the video game may include a game identifier (e.g. an alphanumeric identifier or code), a game session identifier, the game title, game publishers or game developers and/or the game version. Data associated with the game system being used by the video could include its IP address, a system identifier (e.g. an alphanumeric identifier or code identifying the system), and/or details of the manufacturer or model of the system. Data associated with the video game player (which may be similar to or the same as data associated with the channel/account discussed above) may include their name, email address, IP address, a unique identifier or username, social network identifiers (e.g. details of linked social media accounts), age, gender and/or location. In addition, the data associated with the video game player may include their relationship with the live streaming service. In some cases this information relating to the video game player may be similar to the details of the live streaming channel discussed above. Together this data may define the live stream. These details may provide sufficient information to the ad server to identify whether an in-game ad exists in the live stream, to identify the specific in-game ad within the live stream and to select a suitable or appropriate asset to present to a viewer as part of a complementary ad which is linked in some manner to the in-game ad.

In particularly preferred examples the data associated with the live stream comprises a game session identifier and a live stream session identifier. In further preferred examples the data comprises a game identifier, an IP address the video game player and/or the channel broadcasting the live stream (which may be identical) and a timestamp of the live stream.

Optionally, the notification from the live streaming system may comprise data associated with the viewer. For instance, the data associated with the viewer may comprise one or more of their: Internet Protocol (IP) address; location; age; sex; language(s) (e.g. language(s) spoken by the viewer and/or a system language by which the viewer is interacting with the live streaming system); internet browsing habits; unique viewer identifier; relationship with the video game player and/or the channel broadcasting the live stream; relationship with the live streaming service; user device; and previous exposure to in-game advertisements and/or complementary advertisements.

The relationship between the viewer (a user of the live streaming service) and the live streaming service may include that the viewer is an authorised user, a type of user that that is authorized on the live streaming service, and for which data easily identified by the live streaming system and transferred to the ad server with the notification. Alternatively, the viewer may be an authorized obfuscated user who is authorized on the live streaming service but whose privacy settings restrict the disclosure of sensitive information by the live streaming system, in which case the data transmitted to the ad server with the notification may be anonymised or reduced. In further examples the user may be non-authorized, such that the user identity cannot be precisely recognised by the live streaming service. In this case the amount of data associated with the viewer transmitted to the ad server may also be reduced.

A viewer who is an authorised or authorized obfuscated user may have a variety of relationships with the channel and/or video game player broadcasting the live stream. For instance, such a user may be a subscriber of a channel and/or video game player and may pay a subscription to the live streaming service to support the channel and/or video game player. Additionally, or alternatively, the user may be a “follower” of a channel and/or video game player, such that they may receive notifications regarding the channel and/or video game player. In further examples a viewer who is an authorised or authorized obfuscated user may be a platform partner—i.e. a user who has been accepted by a streaming service partnership program that enables additional features for the user as a broadcaster. In most platforms this allows the user to enable platform advertisement on their own channel for live streaming, which results in additional income for said user when live streaming

Preferably the method comprises the step of determining that the asset is suitable to be presented to the viewer based on the data in the notification from the live streaming system. Such methods offer significant benefits. In particular, complementary ads can be presented to viewers that not only relate to or match in-game advertising content, but also are appropriate and suitable to specific viewers. This offers increased safety since minors and other vulnerable groups can be prevented from seeing inappropriate content. In addition, ads can be targeted at specific groups of viewers, leading to more effective advertising campaigns. This allows for more effective and efficient advertising campaigns, reducing overall resource requirements. For instance, the ad server may determine that an asset for a complementary ad for an alcoholic beverage, tobacco product or other restricted product is unsuitable or inappropriate for a viewer based on the age of the viewer. Equally, the ad server may determine that an asset for a complementary ad for a European product or a European advertising campaign is unsuitable for a viewer outside Europe.

Preferably, providing an asset of said one or more asset to the live streaming system may comprise: transmitting the asset to the live streaming system; instructing an asset database to transmit the asset to the live streaming system; or transmitting to the live streaming system information regarding where the live streaming system may obtain the asset. The first of these options is most appropriate where the assets are stored by the ad server. Information regarding where the live streaming system may obtain the asset preferably includes at least a location the asset (e.g. an asset database) and an asset identifier.

Optionally, the method comprises: identifying assets of two or more complementary advertisements which relate to the in-game advertisement; and selecting a complementary advertisement for presentation to the viewer based on the data in the notification from the live streaming system; and providing the asset of the selected complementary advertisement of said two or more creatives to the live streaming system, such that the live stream may be presented to the viewer together with the selected complementary advertisement comprising said asset. For example the ad server may perform a ranking process to identify the complementary ad that is—for instance—most relevant to the in-game ad or more appropriate for the viewer.

Preferably the method comprises sending ad metadata to the live streaming system, the ad metadata defining how and/or when the complementary advertisement should be presented to the viewer. This ad metadata may define the format of the complementary ad, and its timings. For example the metadata may instruct the live streaming system and/or a user device to present the complementary ad before, together with or after the in-game ad is shown to the viewer within the live stream.

Optionally, the method comprises: receiving from a video game system on which the video game is being played a request for an in-game advertisement asset to be inserted as at least part of an in-game advertisement into a video game; and providing an in-game advertisement asset to the video game system. Thus the ad server may provide both the in-game advertisement to a video game system broadcasting the live stream and the complementary advert to be displayed with the live stream.

Optionally, the ad server is remote from the live streaming system.

Preferably the method comprises receiving a notification from a video game system on which the video game is being played of an in-game event; and wherein the step of providing the asset of the live streaming system is performed in response to receiving the notification from the video game system. Thus the complementary ad may be presented to the viewer following or in conjunction with the in-game event that will be seen or heard by the viewer as video of gameplay from the video game is broadcast during the live stream. In particularly preferred examples the in-game event may include the display of the in-game ad to the video game player or actions taken by the video game player within the video game (e.g. the video game player instructing the video game to open a menu, or instructing a virtual character to enter a new area of a virtual world).

In some preferred examples the ad server performs the step identifying an asset of a complementary advertisement which relates to the in-game advertisement based on the data in the notification before providing the asset to the live streaming system. However, this is not essential.

In equally preferred examples the method may comprise providing assets of one or more complementary advertisements to the live streaming system; and subsequently: identifying a complementary advertisement of said one or more complementary advertisements which relates to the in-game advertisement based on the data in the notification; instructing the live streaming system to present the identified complementary advertisement to the viewer, such that the live stream may be presented to the viewer together with the selected complementary advertisement. Thus assets of one or more complementary advertisements may be cached or stored by the live streaming system or the user device. Subsequently, one or more of the complementary advertisements may be displayed and/or sounded to the viewer on instruction from the ad server. This may reduce latency in the provision of complementary ads.

Optionally, the method may comprise comparing the data associated with the live stream received in the notification with data associated with one or more video game sessions, so as to determine which video game session is broadcast within the live stream. Thus the ad server may perform a matching process to link or match a video game session running on a given video game system with the live stream broadcast from said video game system. Subsequently the ad server may record this relationship—e.g. through a shared identifier of the video game session and the live stream. Such steps may avoid the need for the video game system or the live streaming system to define the relationship and improve integration of the systems for providing complementary ads within the existing streaming architecture.

Optionally, the method further comprises receiving and storing display metrics from the live streaming system defining the manner in which the complementary advertisement and/or the in-game advertisement are presented to the viewer. Therefore, the ad server may aggregate display metrics defining the impact of the in-game ad and/or the complementary ad on the viewer. The ad server may be further configured to output reports comprising these display metrics which may allow advertisers to understand advertisement campaign delivery and performance

The display metrics associated for either the complementary ad or the in-game ad may include: a campaign ID; the complementary ad asset(s); the in-game ad asset(s), data defining the relationship between the complementary ad asset(s) and the in-game ad asset(s); impression timestamps (i.e. when the ad(s) were displayed); viewability information: visibility, time in view, screen occupancy, and/or view angle. Furthermore, the ad server may store and report any of the metadata of the live stream, data associated with the video game, data associated with the video game system on which the video game is being played and/or data associated with the video game player who is live streaming the video game discussed above together with the display metrics.

In accordance with further aspects of what is disclosed herein there are provided an ad server configured to perform any of the methods discussed above and a non-transitory computer readable medium storing instructions that, when read by a processor, cause the processor to perform any of the methods discussed above.

In accordance with a further aspect of what is disclosed herein there is provided a method performed by a live streaming system comprising the steps of: sending a notification to an ad server informing the ad server of a live stream being broadcast or to be broadcast by the live streaming system to a user device, the live stream comprising video of game play from a video game and an in-game advertisement; wherein the notification comprises data associated with the live stream; receiving an asset of a complementary advertisement which relates to the in-game advertisement; and providing the asset to the user device, such that the live stream may be presented to a viewer together with a complementary advertisement comprising the asset.

In accordance with further aspects of what is disclosed herein there are provided a live streaming system configured to perform a method according to the preceding aspect of what is disclosed herein and a non-transitory computer readable medium storing instructions that, when read by a processor, cause the processor to perform any of the methods discussed above.

Such live streaming systems offer corresponding benefits to the ad servers discussed above, and may comprise any of the optional features and perform any of the optional steps performed by the live streaming systems discussed above.

In accordance with a further aspect of what is disclosed herein there is provided a system comprising an ad server and a live streaming system according to the preceding aspects of what is disclosed herein. Preferably the system comprises one or more use devices and one or more video game systems.

### BRIEF DESCRIPTION OF DRAWINGS

Specific examples of what is disclosed herein will now be discussed with reference to the following figures:

FIG. 1 shows schematically a system for providing in-game advertisements to a video game player including illustration of flows of information through the system;

FIG. 2 shows schematically a system for providing complementary advertisements to a viewer of a live stream in accordance with some aspects including illustration of flows of information through the system;

FIG. 3 shows schematically a system for providing complementary advertisements to a viewer of a live stream in accordance with some aspects including illustration of flows of information through the system;

FIG. 4 shows schematically a system for providing complementary advertisements to a viewer of a live stream in accordance with some aspects including illustration of flows of information through the system;

FIG. 5 shows schematically a system for providing complementary advertisements to a viewer of a live stream in accordance with some aspects including illustration of flows of information through the system;

FIG. 6 shows schematically a system for providing complementary advertisements to a viewer of a rebroadcast live stream in accordance with some aspects including illustration of flows of information through the system.

### DETAILED DESCRIPTION

Before considering the provision of complementary advertisements to live stream viewers, devices, systems and methods for inserting in-game advertisements into video games will first be discussed.

FIG. 1 shows schematically a system 10 for providing in-game advertisements (“in-game ads”) to at least one video game system 14. The system 10 comprises an ad server 12 and a video game system 14 of a video game player.

The video game system 14 comprises one or more processors that are configured to run one or more of: a video game 14a, a software development kit (SDK) 14b and (optionally) a streaming module 14c. Thus, as shown in FIG. 1, on the video game system 14 are operating the video game 14a, the SDK 14b and the streaming module 14c. In alternative examples the SDK may be replaced by a software library, the functions and processes of the SDK discussed herein being performed by the software library. Such a software library could be provided in a software stack within the video game. Equally, any other suitable component or module may be provided to perform these functions and processes.

The video game 14a is configured to present in-game ads. The video game system 14 is configured to incorporate or insert assets for in-game ads into the video game 14a. The ad server 12 is configured to provide assets for such in-game ads that may be shown to the video game player within the video game 14a. These assets may include one or more image, animation, video, text or audio assets. Preferably the in-game ads are inserted seamlessly into the virtual world of the video game 14a.

The method of providing in-game advertisements to at least one video game player using the system 10 comprises the initial step s101 in which the video game system 14 requests one or more assets for an in-game ad from the ad server 12. Specifically, the SDK 14b may notify the ad server 12 that a video game session using the video game 14a has begun, and request an advertising asset to be incorporated into the video game 14a as at least part of an in-game ad. This request may include data relating to the video game session, the video game system 14 and/or the video game player.

Upon receiving the request, the ad server 12 identifies an asset to be presented to the video game player and provides this asset to the video game system 14 in step s102. Subsequently, the received asset is incorporated into the video game 14a by the video game system 14 as an in-game ad and is presented to the video game player (and any further observers) by the video game system 14. For instance, if the asset is a sound (e.g. the jingle of an advertiser) this sound may be played to the video game player by the video game system 14 during game play. Similarly, an image sent by the ad server to the video game system 14 may be presented to the video game player by an output device that the video game system 14 comprises or is connected to (e.g. a monitor, loudspeaker, television or integral display screen). It will be appreciated that if the video game system 14 is live streaming (i.e. broadcasting) the in-game ad will also be presented to viewers of the live stream.

To provide the assets to the video game system 14 the ad server 12 may transmit the asset to the video game system 14. This may be appropriate if the asset is stored locally to the ad server 12. Alternatively, the ad server 12 may instruct an asset database (not shown) to transmit the asset to the video game system 14 or transmit to the video game system 14 information regarding where the video game system 14 may obtain the asset (e.g. the location of an asset database at which the asset is stored and an asset identifier).

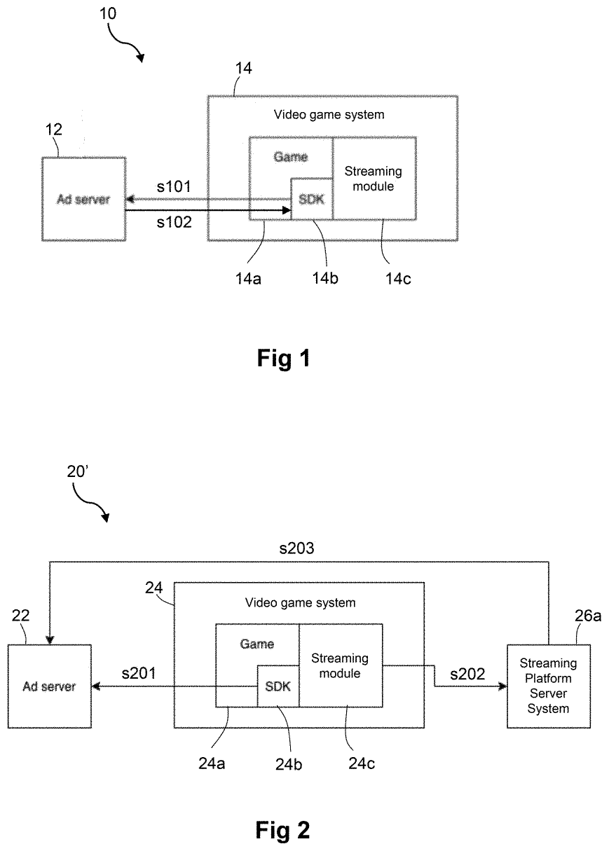

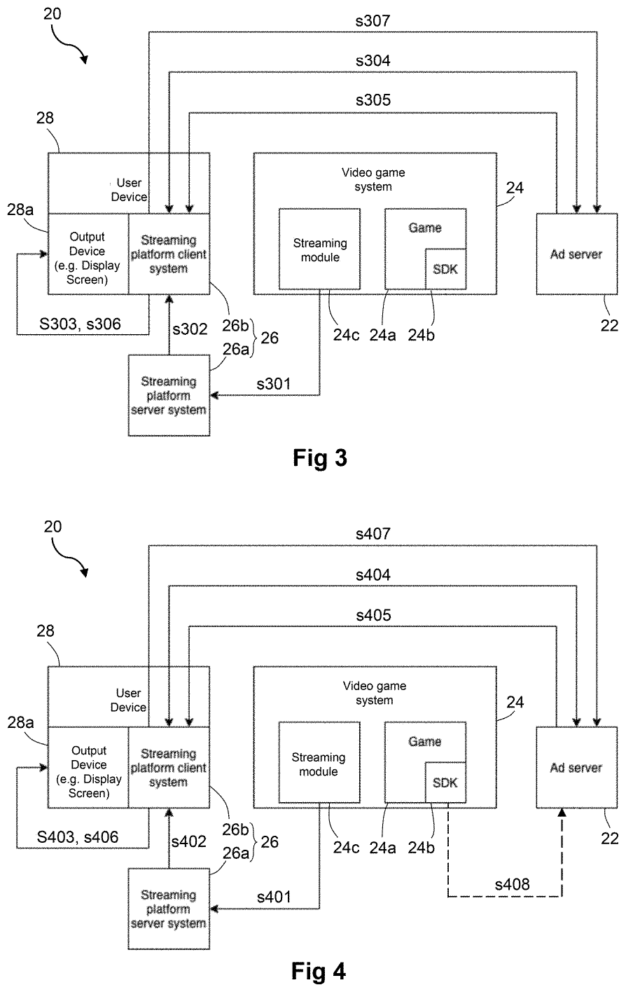

Next devices, systems and processes for providing complementary advertisements (“complementary ads”) to these viewers will be discussed with reference to FIGS. 2 to 3. Such complementary ads correspond or relate to an in-game ad contained within footage or video of a video game within a live stream. The link between the in-game and complementary ads can reinforce the effect of the advertisements on a viewer, increasing the effectiveness and efficiency of providing an advertising campaign.

FIG. 3 shows a system 20 comprising an ad server 22, a video game system 24, a live streaming system 26 and a user device 28. The video game system 24 comprises one or more processors that are configured to run one or more of: a video game 24a, a software development kit (SDK) 24b and a streaming module 24c. Thus, as shown in FIG. 2, on the video game system 24 operate the video game 24a, the SDK 14b and the streaming module 24c. The live streaming system 26 is distributed and comprises a streaming platform client system 26b located on the user device 28 and a remote (e.g. cloud-based) streaming platform server system 26a. In addition to the streaming platform client system 26b, the user device 26 further comprises an output device 28a such as a display screen through which a viewer operating the user device 26 may view the live stream.

A subset 20′ of the wider system 20 shown in FIG. 3 is illustrated in FIG. 2. Specifically, FIG. 2 shows the ad server 22, video game system 24 and the streaming platform client system 26b are shown in FIG. 2 (the remaining components being omitted from the figure for clarity).

As in the system 10 of FIG. 1, the video game 24a of the system 20 shown in FIGS. 2 and 3 is configured to present in-game ads to a video game player whilst the video game system 24 is configured to insert advertising assets into the video game 24a as in-game ads. In addition, the video game system 24 is configured to simultaneously run the video game 24a incorporating the in-game ad, and to transmit a live stream of game play from the video game 24 to the live streaming system 26. This live stream is in turn transmitted to the user device 28 by the live streaming system 26 where it can be seen by a viewer using the output device 28a such as a display screen, speaker and/or any other suitable output devices. Thus the user device 28 is configured to present the live stream and an accompanying complementary advertiser using said output device(s).

Methods of displaying complementary ads to viewers of a live stream will now be discussed with reference to the flows shown in FIGS. 2 and 3. First, a video player begins to play the video game 24a configured to display in-game ads. Thus the video game system 24 instantiates a video game session and begins running the video game 24a.

In preferred examples the ad server 22 may be configured to provide assets of in-game ads to the video game system 24 for insertion into the video game 24a as an in-game ad. As such, the ad server 22 may provide assets to the video game system 24 according to the methods discussed above with reference to FIG. 1. However, this is not essential, and in further embodiments the video game system 24 may receive assets for the in-game from a separate, specific in-game ad server (not shown).

In step 201 the video game system 24 informs the ad server 22 of the video game session. Specifically, the SDK 24b of the video game system 24 sends a notification to the ad server 22 informing the ad server 22 that the video game session exists. This step may be performed, for instance, when the video game 24a is first started by the video game system 24, when the video game player logs into the video game 24a, or when an in-game advertisement is first inserted into the video game 24a during the video game session.

The notification from the video game system 22 in step s201 may comprise data associated with the video game session, such as information about the video game 24a itself, the video game system 24 and/or the video game player. For instance the data may include a game identifier, IP address of the video game system, timestamp, an identifier or other information regarding the video game player, as well as specific information relating to the video game 24a or the video game system 24.

Subsequently, the video game player operates the video game system 24 to start broadcasting a live stream. The streaming module 24c of the video game system begins transmitting video (and preferably audio) of the video game 24a in real time to the streaming platform server system 26a together with data associated with the video game player and the video game system 24 in step s202.

Subsequently, the live streaming system 26 informs the ad server 22 of the existence of the live stream broadcast from the video game system 24. This occurs in step s203 as the streaming platform server system 26a sends a notification to the ad server 22 in step s203 comprising data associated with the live stream. For example the data associated with the live stream sent by the streaming platform server system 26a may include a game identifier, IP address of the video game system, timestamp and information specific to the video game 24a or the video game system 24. This information transmitted by the streaming platform server system 26a to the ad server 22 may include items of information previously received from the streaming module 24c in step s202.

Thus the ad server 22 receives information regarding the video game session and the live stream through steps s201 and s203 respectively. This information is subsequently stored by the ad server 22 (e.g. stored within a database comprised within the ad server 22 or within a database in communication with the ad server 22). It should be appreciated that steps 201 and 203 may occur in any order. For instance, the ad server 22 may receive information regarding the video game session from the video game system 24 before, after or substantially simultaneously to when the ad server 22 receives information regarding the live stream from the live streaming system 26.

Although only a single video game system 24 is shown in FIG. 2, in practice the ad server 22 will typically be simultaneously in communication with large numbers of video game systems 24 running video games configured to present in-game ads to the respective video game player. Equally, many video game players may be live streaming the game play from their respective video game system 24 at any given time. Thus during operation, the ad server 22 will typically receive and store data associated with a plurality of active video game sessions running on a plurality of video game systems (analogously to step s201) and receive and store data associated with a plurality of live streams broadcast from a subset of these video game systems (analogously to step s203 in FIG. 2).

Consequently, in order to provide complementary advertising to a viewer watching the live stream broadcast from video game system 14 shown in FIGS. 2 and 3 it may be necessary to record and store the relationship between a live stream that is broadcast from any given video game system and the video game session running said video game system.

In some cases this relationship may be defined by the video game system in question or the live streaming system and subsequently transmitted to the ad server 22. However, in preferred examples, the relationship between the live stream and video game sessions is achieved through a matching process performed by the ad server 22. This has the benefit that the resource requirements at the video game systems and live streaming systems are minimized, and network traffic between these systems and the ad server 22 may be reduced.

A matching process performed by the ad server 22 may be invoked after the ad server 22 receives a notification from a live streaming system that a live stream of a video game has begun, said video game being configured to present an in-game ad (as in step s203). The ad server 22 compares the data associated with the live stream within this notification to the data associated with video game sessions stored by the ad server 22 (this information has been received from notifications of video game sessions from video game systems as in step s201). In other words, the ad server 22 compares metadata regarding video game sessions received from video game systems with metadata regarding live streams received from live streaming systems in order to define relationships between the video game sessions and live streams and determine which video game session is displayed in which live stream.

The ad server 22 may attempt to identify an active video game session that most closely matches the live stream in question. For instance, the ad server 22 may determine that a video game session matches a live stream if sufficient numbers of pieces of data are consistent between the data associated with the live stream and the data associated with the video game session. For instance, the ad server may determine that a live stream and a video game session match if they share two or more of the following pieces of information: an IP address of the video game system; a game identifier; a timestamp; device information of the video game system; and game specific information regarding the video game.

If a match is found between the live stream and an active video game session, the ad server 22 may record or store the relationship between a broadcast session identifier of the live stream to the video game session identifier. For instance the ad server may define a unique identifier defining the matched live stream and video game session.

However, if no match is found, the ad server 22 may periodically repeat the matching process in an attempt to identify a corresponding video game session shown within the live stream. For instance, the matching process may be performed for unmatched live streams every thirty seconds, every minute or every five minutes. To reduce resource requirements, the ad server 22 may stop this repetition of the matching process after a predetermined period of time or after a predetermined number of matching attempts.

In particularly preferred examples the ad server 22 may account for previous matches defined between live streams and video game sessions when performing the matching process for subsequent live streams. The ad server 22 may not compare data associated with the subsequent live stream to data associated with video game sessions which have already been matched to a live stream.

If no match is found the ad server 22 may periodically repeat the matching process in an attempt to identify a corresponding video game session. For instance, the matching process may be performed every thirty seconds, every minute or every five minutes. To reduce resource requirements, the ad server 22 may periodically repeat the matching process a predetermined number of times or for a predetermined amount of time. If a match is found during these subsequent matching processes the session identifies may be linked as discussed above.

Returning to the system 20 shown in FIGS. 2 and 3, after the ad server receives the notification from the streaming platform server system 26a of the live streaming system 26 the matching process discussed above is performed. A link between the live stream broadcast by the video game system 24 and the video game session running on the video game system 24 is defined and recorded by the ad server.

Subsequently, complementary advertisements that relate or correspond to in-game ads within the live stream are distributed to the user device(s) 28 and presented to a viewer together with the live stream. The process of distributing and presenting these complementary ads will now be discussed in reference to the flows shown in FIG. 3.

As discussed above, the video game system 24 broadcasts a live stream to the user device 28 via the live streaming system 26. The streaming module 24c of the video game system 24 transmits video (and preferably audio) of the video game 24a to the streaming platform server system 26a as shown by step s301 in FIG. 3 (a continuation of the broadcast shown in step s202 of FIG. 2). Subsequently, the streaming platform server system 36a transmits the video (and preferably audio) to the streaming platform client system 36a during step s302. In step s303 the user device 38 displays the live stream received by the streaming platform client system 36b to the viewer using the output device 48a.

Thereafter, live streaming system 26 informs the ad server 22 that the live stream is being broadcast to the viewer. Specifically, in step s304 the streaming platform client system 26b sends a notification to the ad server 22 that indicates that the live stream is being broadcast to a viewer. This notification informs the ad server that the live stream is being watched by an end user (i.e. a viewer) on the user device 28 (i.e. a viewer). The notification includes data associated with the live stream. Such data associated with the live stream may correspond to or include similar data to the information provided to the ad server 22 by the streaming platform server system 26a in step s203 shown in FIG. 2. In some embodiments the notification performed in step s304 may take the form of a request for an asset for complementary ad from the live streaming system 26 and prompt the ad server 22 to provide an asset directly. However, this is not essential and the ad server 22 may determine that an asset should be provided to the ad server separately or subsequently to receive the notification.

Preferably step s304 further comprises the opening of a connection between the streaming platform client system 26b and the ad server 22 by which complementary ads may be provided to the streaming platform client system 26b. This connection may be persistent, being maintained by the streaming platform client system 26b and the ad server 22 throughout the transmission of the live stream to the user device 28.

It will be appreciated that steps s303 and s304 may be performed in any order. The streaming platform client system 26b may inform the ad server 22 about the live stream during the display of the live stream and/or before display of the live stream has commenced.

Subsequently, the ad server 22 identifies one or more advertising assets of complementary ads that relate to the in-game ad shown within the live stream, before the ad server provides the streaming platform client system 26b with at least one of these assets in step s305. Complementary ads incorporating the assets provided by the ad server 22 are subsequently provided (e.g. transferred or transmitted) to the user device 28 by the streaming platform client system 26b and the complementary ads are presented to the viewer together with the live stream by the user device 28 via the output device 28a in step s306.

To identify the assets to be used within the complementary ads the ad server may first identify that the live stream being presented by the user device 28 to the viewer contains an in-game ad and identify the in-game ad present within the live stream. This may be based on the data associated with the live stream provided to the ad server 22 by the user device 28 in the notification of step s304. The ad server 22 may compare this information with the live stream (e.g. a live stream identifier) with a stored list of matched live streams and video game sessions discussed above, so as to identify the video game session that is to be displayed or is being displayed to a viewer via the user device 28. The ad server 22 may then use this matched video game session to identify whether the live stream does contain an in-game ad and/or which in-game ad is being presented in the live stream.

If the ad server 22 that is configured to provide the complementary ad also provides assets for in-game ads to video game systems (i.e. the ad server 22 is configured to perform the steps discussed above with reference to FIG. 1) the ad server 22 may compare the video game session identified above to records of which in-game ads have been provided to which

Alternatively, the ad server 22 may request information regarding any in-game ads from a separate ad server configured to provide in-game ads to video game systems (e.g. the ad server 12 shown in FIG. 1).

As discussed above, having identified the in-game ad present within the live stream being broadcast to the viewer by the user device 28 the ad server 22 identifies any suitable complementary ads that relate to the in-game ad. These relationships between complementary ads and in-game ads may be predefined or pre-determined—e.g. during the launch of an advertising campaign. If two or more complementary ads are identified that relate to the in-game ad, the ad server 22 may perform a ranking process to identify a complementary ad to be displayed to the viewer. This may be based on data associated with the viewer received from the streaming platform client system 26b.

In particularly preferred methods the ad server may determine whether a complementary ad that relates to the in-game ad is appropriate or suitable for the viewer using the user device 28. The ad server 22 may use the information regarding the viewer received from the live streaming system 26 in step s304 to perform this determination. As an example, the complementary ad may be only be appropriate for a predefined subset of viewers (e.g. viewers over a certain age, or of a specific gender). In other words, the complementary ad may be considered suitable for only a specific audience. The data associated with the viewer using the user device 28 may be compared to these predetermined audience requirements of the complementary ad so as to determine whether the complementary ad is appropriate or suitable for the viewer. Alternatively, the ad server 22 may track how recently a complementary ad was last presented to each viewer using the respective information regarding each viewer, and determine that it is only suitable to display the complementary ad to a given viewer if it has not been presented to said viewer before and/or if a certain time has elapsed since the viewer has last seen the complementary ad (e.g. at least 1 hour, 6 hours or 24 hours has elapsed).

In such cases, only the assets of complementary ads determined to be suitable for the viewer may be provided to the streaming platform client system 26b in step s305, and transferred to the user device 28a and presented to the viewer in step s306. Thus the provision of complementary advertising is made more effective and efficient, and public safety may be improved since complementary ads are only provided to appropriate viewers.

To provide the assets to the streaming platform client system 26b of the live streaming system 26, the ad server 22 may transmit the asset to the streaming platform client system 26b. This may be appropriate if the asset is stored locally to the ad server 26. Alternatively, the ad server 22 may instruct an asset database (not shown) to transmit the asset to the streaming platform client system 26b or transmit to the streaming platform client system 26b information regarding where the streaming platform client system 26b may obtain the asset (e.g. the location of an asset database at which the asset is stored and an asset identifier).

In addition to providing assets for complementary ad to the streaming platform client system 26b in step s305, the ad server 22 may also transmit ad metadata that is specific to the streaming platform client system 26b. The ad metadata may define how and/or when a complementary ad incorporating these assets should be presented to the viewer. For instance, the ad metadata may define the format of the complementary ad, the length the complementary ad is displayed for, and a timestamp at which display of the complementary ad should commence. Thus the user device 28 may display the complementary ad to a viewer in accordance with any received ad metadata during step s506.

Throughout the display of the live stream and the presentation of the complementary ad to the viewer by the output device 28a of the user device 28 the streaming platform client system 26b may aggregate and collect one or more display metrics defining the manner in which the complementary ad and/or the in-game ad are presented to the viewer. The display metrics may include time on screen, visibility, screen occupancy and others. The streaming platform client system 26b may transmit the display metrics to the ad server 22 in step s307—e.g. after presentation of the complementary ad has finished, after the live stream has finished, and/or after the viewer stops viewing the live stream using the user device 28.

The ad server 22 may be configured to store the aggregated display metrics from each of the viewing devices with which it is in communication, and subsequently output a report regarding the display metrics of a complementary ad across all of said viewing devices.

Thus the system 20 shown in FIGS. 2 and 3 is capable of presenting complementary ads to a viewer using the user device 28 in combination with a live stream from the video game system 24 that comprises an in-game ad, and of reporting on the success of these complementary ads.

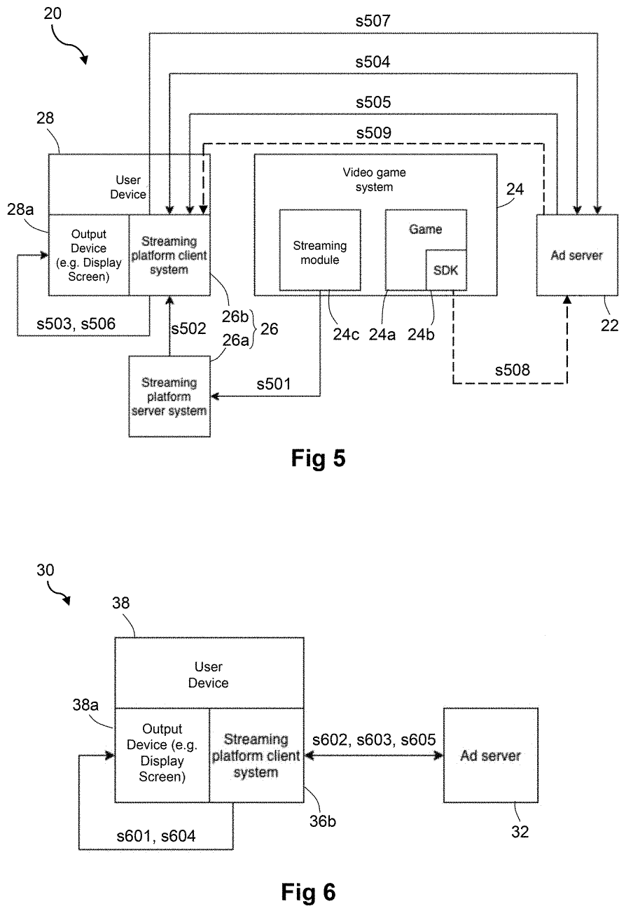

Further optional steps that may be performed by systems according to some aspects during methods of providing complementary ads will now be discussed with reference to FIGS. 4 and 5.

FIGS. 4 and 5 shows a system 30 that comprises the similar physical components as the system 20 of FIGS. 2 and 3. The components shown in FIGS. 4 and 5 retain the same reference signs as the corresponding components in FIGS. 2 and 3 and may offer any of the features, perform any of the steps and provide equivalent advantages of the corresponding components of FIGS. 2 and 3.

The modified method of providing complementary ads shown in FIG. 4 is performed in substantially the same manner as discussed above with reference to FIGS. 2 and 3. The flow of information through the system 20 during this method is illustrated by steps s401 to s408 in FIG. 4. Corresponding flows have had their reference signs incremented by 100 between FIGS. 3 and 4. The major difference between the methods performed in FIGS. 3 and 4 is that assets of complementary ads are transmitted to the user device 28 in response to in-game events reported to the ad server 22 by the video game system 24.

As in FIG. 3, the video game system 24 shown in FIG. 4 broadcasts a live stream of the video game 24a containing an in-game ad to the streaming platform client system 26b of the live streaming system 26 via the streaming platform server system 26a (steps s401 and s402). The live stream received by the streaming platform client system 26b is then displayed to the viewer by the user device 28 using an output device 28a (step s403) and the streaming platform client system 26b of the live streaming system 26 informs the ad server 22 of a live stream that is being presented or is to be presented to the viewer by the user device (step s404).

However, in contrast to FIG. 3, the ad server 22 provides assets of complementary ads to the streaming platform client system 26b (step s405) in response receiving a notification from the SDK 24b within the video game system 24 of an in-game event in optional step s408. For instance, the video game system 24 may inform the ad server 22 of the display of an in-game ad to video game player (which will subsequently be broadcast to the viewer via the live stream) which may trigger the ad server 22 to provide the assets to the user device 28 such that the complementary ad may be presented to the viewer in tandem with the in-game ad. Thus the assets for complementary ads are provided by the ad server 22 in response to the notification from the SDK 24b, and not in response to a notification or request from the live streaming system 26 as discussed above with reference to FIG. 3. This may allow complementary ads to be presented to the viewer in a manner that corresponds to the timing or location of an in-game ad within the live stream and may minimize network traffic by reducing unnecessary transfer of advertising assets.

After the streaming platform client system 26b receives the assets of the complementary ad, the complementary ad is provided (i.e. transferred) to the user device 28 and displayed to the viewer with the live stream (step s406). The streaming platform client system 26b aggregates display metrics defining the impact of the in-game ad and/or the complementary ad on the viewer and transmits these metrics to the ad server 22 (step s407). The ad server 22 may store and/or issue reports regarding these display metrics. These reports may be provided to advertisers to understand advertisement campaign delivery and performance

FIG. 5 illustrates another modified version of the method for providing complementary ads performed using the system 20 in which complementary ads are pre-cached on the user device 28. This modification is illustrated by steps s501 to s509 in FIG. 5. Corresponding flows have had their reference signs incremented by 200 between FIGS. 3 and 5 and by 100 between FIGS. 4 and 5.

As in FIG. 3, the streaming module 24c of the video game system 24 shown in FIG. 5 transmits a live stream of the video game 24a to the user device 28 via the live streaming system (steps s501 and s502). The live stream is displayed to the viewer by the user device 28 using an output device 28a (step s503), whilst the streaming platform client system 26b informs the ad server 22 of the live stream that is being presented or is to be presented to the viewer by the user device 28 (step s504).

In response to receiving a notification that a live stream is being presented or is to be presented to the viewer the ad server 22 provides a plurality of assets to the streaming platform client system 26b of the user device 28 in step s505. For instance, the ad server 22 may provide assets for a plurality of complementary ads to the live streaming system 26. This may occur immediately after the ad server 22 receives the notification in step 504. The asset(s) received by the streaming platform client system 26b are cached (i.e. stored) on the user device 28 by the streaming platform client system 26b. The streaming platform client system 26b waits for further instructions from the ad server 22 to present complementary ads to the viewer.

Subsequently, the ad server 22 may issue an instruction to the streaming platform client system 26b to present a complementary ad comprising one or more of the cached assets to the viewer with the live stream using the output device 28a of the user device 28 in step s509. This instruction may be issued by the ad server in response to the streaming platform system. The instruction may contain ad metadata defining how and/or when the complementary ad should be displayed. The ad server 22 may be configured to issue this instruction in step 509 in response to receiving a notification of a game event from the video game system 24 (s508) as discussed above with reference to FIG. 4.

Subsequently the complementary ad is passed to the user device 28 by the live streaming client system 26b and is displayed to the viewer by the user device 28 with the live stream (step s506) in accordance with any received ad metadata and the streaming platform client system 26b aggregates and reports on display metrics to the ad server 22 (step s507).

Such methods may minimize latency or delay between the live stream and any complementary ads displayed by the user device. In addition, the user device 28 may receive assets for complementary ads before streaming and displaying the live stream to the viewer. This may minimize the impact of providing complementary ads on the quality of the live stream.

In the discussions above, it has been assumed that the live stream has been recorded and broadcast to the user devices in real time. However, this is not essential and complementary ads may also be presented to a viewer who is watching a replay of a live stream containing an in-game ad. Such examples will now be discussed with reference to FIG. 6.

FIG. 6 shows a system 30 comprising an ad server 32 and a user device 38. The user device comprises an output device 38a (e.g. a display screen) and a streaming platform client system 36b, which may form part of a larger live streaming system.

In an initial step the streaming platform client system 36b of the live streaming system receives a previously recorded live stream. This may be received from, for instance, a streaming platform server system on which live streams are stored as they are broadcast. The live stream comprises video of game play of a video game and an in-game ad, and may have been initially broadcast from a video game system to a live stream system as discussed with reference to steps s202 and s301 in FIGS. 2 and 3.

After receiving the live stream, the user device 38 displays the live stream to a viewer using the output device 38a in step s601. Streaming platform client system 36b also sends a notification to the ad server 32 informing the ad server 32 of the live stream it is receiving in step s602. This notification may comprise data associated with the live stream. These two steps may be performed in either order.

In response to this notification, the ad server 32 may respond by providing any available assets of complementary ads to the streaming platform client system 36b in step s603. The ad server 32 may in addition provide ad metadata defining when and/or how these complementary ads should be presented to the viewer during this step 603. For instance the ad metadata may comprise one or more timestamps, each indicating when during the recorded livestream a respective complementary ad should be displayed or presented to the viewer by the user device 38. The complementary ads and their assets may have been identified and determined to be related to the in-game ads within the live stream by the ad server during the original broadcast of the live stream through a process as described with reference to FIGS. 2 to 5. Similarly, any ad metadata may have been defined for each complementary ad by the ad server 32 during the original broadcast of the live stream as discussed above.

Subsequently, the user device 38 presents complementary ads comprising the assets received from the ad server 32 to the viewer using the output device 38a together with the live stream in step s604. The complementary ads may be presented in accordance with any ad metadata received from the ad server 32.

During the display of the complementary ad and/or any in-game ad the streaming platform client system 36b may aggregate one or more display metrics associated with the manner in which the complementary ad and/or the in-game ad are presented to the viewer (e.g. time on screen, visibility, screen occupancy). The streaming platform client system 36b may subsequently transmit these display metrics to the ad server 32 in step s605. The ad server 32 may store the display metrics received in this manner and may issue reports summarizing the display metrics across a fleet of user devices periodically or on request.

Therefore, complementary ads can be presented to a viewer of a replayed live stream based on data and information collected during the active video game session and the live stream.

In each of the examples shown in FIGS. 3 to 6 the ad server 22, 32 communicates directly with the streaming platform client system 26b, 36b of a live streaming system 26. However, this is not essential and in further examples the ad server 22, 32 any of the communications between the ad server 22, 32 and the streaming platform client system 26b, 36b may be transmitted by the streaming platform server system 26a. Equally, in further examples the live streaming system may not comprise a server-client architecture and instead all steps performed by the live streaming systems discussed above may be performed by a single module located remotely from user devices 28. In such cases where the component of the live streaming system which receives complementary ad assets from the ad server is remote from user devices 28 the live streaming system may subsequent transmit (i.e. provide) these assets to the user devices 28 such that complementary ads containing said assets may be presented to viewers with the live stream.

The components of the systems discussed above may be connected by wired or wireless connections. In preferred embodiments the ad servers, video game systems, streaming platform server systems and user devices may be located remotely from one another. Preferably the ad servers and streaming platform service systems may be cloud based.

It is important to note that while what is disclosed herein has been described in a context of a fully functioning data processing system, those of ordinary skill in the art will appreciate that the processes of what is disclosed herein are capable of being distributed in the form of a computer readable medium of instructions and a variety of forms and that what is disclosed herein applies equally regardless of a particular type of signal bearing media actually used to carry out distribution.

Generally, any of the functionality described in this text or illustrated in the figures can be implemented using software, firmware (e.g., fixed logic circuitry), programmable or non-programmable hardware, or a combination of these implementations. The terms “component” or “function” as used herein generally represents software, firmware, hardware or a combination of these. For instance, in the case of a software implementation, the terms “component” or “function” may refer to program code that performs specified tasks when executed on a processing device or devices. The illustrated separation of components and functions into distinct units within the block diagrams above may reflect an actual physical grouping and allocation of such software and/or hardware, or can correspond to a conceptual allocation of different tasks performed by a single software program and/or hardware unit. Thus, the various processes described herein can be implemented on the same processor or different processors in any combination.

As mentioned methods and processes described herein can be embodied as code (e.g., software code) and/or data. Such code and data can be stored on one or more computer-readable media, which may include any device or medium that can store code and/or data for use by a computer system. When a computer system reads and executes the code and/or data stored on a computer-readable medium, the computer system performs the methods and processes embodied as data structures and code stored within the computer-readable storage medium. In certain embodiments, one or more of the steps of the methods and processes described herein can be performed by a processor (e.g., a processor of a computer system or data storage system). It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that is capable of storing computer-readable information/data. Computer-readable media should not be construed or interpreted to include any propagating signals.

Although specific embodiments of the disclosure have been described, various modifications, alterations, alternative constructions, and equivalents are also encompassed within the scope of the disclosure. Embodiments of the present disclosure are not restricted to operation within certain specific data processing environments, but are free to operate within a plurality of data processing environments. Additionally, although embodiments of the present disclosure have been described using a particular series of transactions and steps, it should be apparent to those skilled in the art that the scope of the present disclosure is not limited to the described series of transactions and steps. Various features and aspects of the above-described embodiments may be used individually or jointly.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims. The modifications and variations include any relevant combination of the disclosed features.

1. A computer implemented method performed by an ad server, the method comprising:
receiving, using a processor, from a live streaming system a notification informing the ad server of a live stream being broadcast or to be broadcast by the live streaming system to a user device, the live stream comprising video of game play from a video game and an in-game advertisement,
wherein the notification comprises data associated with the live stream;
identifying, using the processor, an asset of a complementary advertisement which relates to the in-game advertisement based on the data in the notification; and
providing, using the processor, the asset to the live streaming system, such that the live stream may be presented to a viewer together with a complementary advertisement comprising the asset.

2. The method according to claim 1, further comprising:
identifying that the live stream comprises an in-game advertisement based on the data in the notification from the live streaming system.

3. The method according to claim 1, further comprising:
identifying the in-game advertisement within the live stream based on the data in the notification from the live streaming system.

4. The method according to claim 1, wherein the data associated with the live stream includes one or more of metadata of the live stream; data associated with the video game, data associated with the video game system on which the video game is being played, and data associated with the video game player who is live streaming the video game.

5. The method according to claim 1, wherein the notification from the live streaming system comprises data associated with the viewer.

6. The method according to claim 5, wherein the data associated with the viewer comprises one or more of the viewer's: Internet Protocol (IP) address, location, age, sex, language(s), internet browsing habits, unique viewer identifier, relationship with the video game player and/or the channel broadcasting the live stream, relationship with the live streaming service, user device, and previous exposure to in-game advertisements, and complementary advertisements.

7. The method according to claim 5, further comprising determining that the asset is suitable to be presented to the viewer based on the data in the notification from the live streaming system.

8. The method according to claim 1, wherein providing an asset of said one or more asset to the live streaming system comprises:
transmitting the asset to the live streaming system;
instructing an asset database to transmit the asset to the live streaming system, or
transmitting to the live streaming system information regarding where the live streaming system may obtain the asset.

9. The method according to claim 1, further comprising:
identifying assets of two or more complementary advertisements which relate to the in-game advertisement;
selecting a complementary advertisement for presentation to the viewer based on the data in the notification from the live streaming system; and
providing the asset of the selected complementary advertisement of said two or more creatives to the live streaming system, such that the live stream may be presented to the viewer together with the selected complementary advertisement comprising said asset.

10. The method according to claim 1, further comprising sending ad metadata to the live streaming system, the ad metadata defining how and/or when the complementary advertisement should be presented to the viewer.

11. The method according to claim 1, further comprising:
prior to the receiving, the identifying, and the providing:
receiving from a video game system on which the video game is being played a request for an in-game advertisement asset to be inserted as at least part of an in-game advertisement into a video game; and
providing an in-game advertisement asset to the video game system.

12. The method according to claim 1, wherein the ad server is remote from the live streaming system.

13. The method according to claim 1, further comprising:
receiving a notification from a video game system on which the video game is being played of an in-game event;
and wherein the providing, using the processor, the asset of the live streaming system is performed in response to receiving the notification from the video game system.

14. The method according to claim 1, further comprising:
providing assets of one or more complementary advertisements to the live streaming system;
and subsequently:
identifying a complementary advertisement of said one or more complementary advertisements which relates to the in-game advertisement based on the data in the notification; and
instructing the live streaming system to present the identified complementary advertisement to the viewer, such that the live stream may be presented to the viewer together with the selected complementary advertisement.

15. The method according to claim 1, further comprising:
comparing the data associated with the live stream received in the notification with data associated with one or more video game sessions to determine which video game session is broadcast within the live stream.

16. The method according to claim 15, further comprising identifying the in-game advertisement within the live stream based on the determined video game session broadcast within the live stream.

17. The method according to claim 1, further comprising:
receiving and storing display metrics from the live streaming system defining the manner in which the complementary advertisement and/or the in-game advertisement are presented to the viewer.

18. An ad server comprising:
a memory storing a plurality of instructions; and
a processor configured to access the memory, the processor further configured to execute the plurality of instructions to at least:
receive from a live streaming system a notification informing the ad server of a live stream being broadcast or to be broadcast by the live streaming system to a user device, the live stream comprising video of game play from a video game and an in-game advertisement,
wherein the notification comprises data associated with the live stream;
identify an asset of a complementary advertisement which relates to the in-game advertisement based on the data in the notification; and
provide the asset to the live streaming system, such that the live stream may be presented to a viewer together with a complementary advertisement comprising the asset.

19. A non-transitory computer readable medium storing instructions that, when executed by a processor, cause the processor to at least:
receive from a live streaming system a notification informing the ad server of a live stream being broadcast or to be broadcast by the live streaming system to a user device, the live stream comprising video of game play from a video game and an in-game advertisement,
wherein the notification comprises data associated with the live stream;
identify an asset of a complementary advertisement which relates to the in-game advertisement based on the data in the notification; and
provide the asset to the live streaming system, such that the live stream may be presented to a viewer together with a complementary advertisement comprising the asset.

20. A computer implemented method performed by a live streaming system comprising:
sending, using a processor, a notification to an ad server informing the ad server of a live stream being broadcast or to be broadcast by the live streaming system to a user device, the live stream comprising video of game play from a video game and an in-game advertisement, the live stream comprising video of game play from a video game and an in-game advertisement,
wherein the notification comprises data associated with the live stream;
receiving, using the processor, an asset of a complementary advertisement which relates to the in-game advertisement; and
providing, using the processor, the asset to the user device, such that the live stream may be presented to a viewer together with a complementary advertisement comprising the asset.

21. A live streaming system comprising:
a memory storing a plurality of instructions; and
a processor configured to access the memory, the processor further configured to execute the plurality of instructions to at least:
send a notification to an ad server informing the ad server of a live stream being broadcast or to be broadcast by the live streaming system to a user device, the live stream comprising video of game play from a video game and an in-game advertisement, the live stream comprising video of game play from a video game and an in-game advertisement,
wherein the notification comprises data associated with the live stream;
receive an asset of a complementary advertisement which relates to the in-game advertisement; and
provide the asset to the user device, such that the live stream may be presented to a viewer together with a complementary advertisement comprising the asset.

22. A non-transitory computer readable medium storing instructions that, when executed by a processor, cause the processor to at least:
send a notification to an ad server informing the ad server of a live stream being broadcast or to be broadcast by the live streaming system to a user device, the live stream comprising video of game play from a video game and an in-game advertisement, the live stream comprising video of game play from a video game and an in-game advertisement,
wherein the notification comprises data associated with the live stream;
receive an asset of a complementary advertisement which relates to the in-game advertisement; and
provide the asset to the user device, such that the live stream may be presented to a viewer together with a complementary advertisement comprising the asset.
